(19) United States
(12) Patent Application Publication
(10) Pub. No.: US 2011/0109534 A1
(43) Pub. Date: May 12, 2011

(54) ELECTRONIC PAPER DISPLAY DEVICE AND METHOD OF MANUFACTURING THE SAME

(75) Inventors: Sang Moon LEE, Seoul (KR); Hwan-Soo Lee, Seoul (KR); Young Woo Lee, Suwon (KR); Jeong Bok Kwak, Suwon (KR)

(73) Assignee: SAMSUNG ELECTRO-MECHANICS CO., LTD., Suwon (KR)

(21) Appl. No.: 12/753,064

(22) Filed: Apr. 1, 2010

(30) Foreign Application Priority Data
Nov. 12, 2009 (KR) 10-2009-0109094

(51) Int. Cl. G09G 3/34; H01J 9/00

(52) U.S. Cl. 345/85; 445/24

(57) ABSTRACT

There is provided an electronic paper display device and a method of manufacturing the same. An electronic paper display device according to an aspect of the invention may include: first and second electrodes facing each other; an elastomer matrix provided between the first and second electrodes and having one or more protrusions spaced apart at predetermined intervals therebetween; and one or more rotary bodies having optical and electrical anisotropy and being disposed within each of the protrusions. An electronic paper display device according to an aspect of the invention includes rotary bodies being densely arranged with a small thickness, thereby improving a contrast ratio and requiring relatively low driving voltage. Furthermore, predetermined intervals within an elastomer matrix provide a space in which the elastomer matrix can be bent, thereby increasing flexibility.

### CROSS-REFERENCE TO RELATED APPLICATIONS

This application claims the priority of Korean Patent Application No. 10-2009-0109094 filed on Nov. 12, 2009, in the Korean Intellectual Property Office, the disclosure of which is incorporated herein by reference.

### BACKGROUND OF THE INVENTION

1. Field of the Invention

The present invention relates to an electronic paper display device and a method of manufacturing the same, and more particularly, to an electronic paper display device having a high contrast ratio, a low driving voltage, and excellent flexibility.

2. Description of the Related Art

A large shift in information exchange and sharing methods is currently in demand, corresponding to modern society's requirement for a new information delivery paradigm. To meet this demand, the development of technologies associated with flexible electronic paper has recently been accelerated and are now entering the phase of commercial development.

Compared with existing flat display panels, an electronic paper display requires relatively low manufacturing costs, and is far superior in terms of energy efficiency since it is operable even with a very low level of energy due to the needlessness of backlighting or continuous recharge. Furthermore, electronic paper enables a high definition display, provides a wide viewing angle, and is equipped with a memory function that retains the display of letters (characters) even when unpowered. The above-described advantages make electronic paper applicable in a wide variety of technical fields, such as electronic books having paper-like sheets and moving illustrations, self-updating newspapers, reusable paper displays for mobile phones, disposable TV screens, and electronic wallpaper. There is a massive potential market for such electronic paper.

A technical approach for the implementation of electronic paper may be roughly divided into four methods: a twist-ball method, an electrophoretic method, a quick response-liquid power display (QR-LPD) method, and a cholesteric liquid crystal display method. Here, the twist ball method involves rotating spherical particles, each having upper and lower hemispheres having opposite electrical charges and different colors, by using an electric field. As for the electrophoretic method, colored charged particles mixed with oil are trapped in micro-capsules or micro-cups, or charged particles are made to respond to the application of an electric field. The QR-LPD method uses charged powder. The cholesteric liquid crystal display method uses the selective reflection of cholesteric liquid crystal molecules.

As for the twist-ball method, cells are filled with a transparent medium, and twist balls, each having opposite electrical charges and colored with different colors, for example black and white, are disposed in the transparent medium. Each twist ball, when receiving voltage, rotates such that the part of its body having an opposite polarity to the received electric charge faces the front. In such a manner, black and white are displayed.

In general, twist balls are arrayed according to a casting method. However, the arrangement of these twist balls is not uniform by the casting method, and voltage having a high level is required to drive the twist balls.

### SUMMARY OF THE INVENTION

An aspect of the present invention provides an electronic paper display device having a high contrast ratio, a low driving voltage, and excellent flexibility.

According to an aspect of the present invention, there is provided a an electronic paper display device including: first and second electrodes facing each other; an elastomer matrix provided between the first and second electrodes and having one or more protrusions spaced apart at predetermined intervals therebetween; and one or more rotary bodies having optical and electrical anisotropy and being disposed within each of the protrusions.

A height of each protrusion may be smaller than a diameter of each rotary body.

The predetermined interval may have a width within a range of 110 to 130 μm.

The elastomer matrix may be at least one selected from the group consisting of polyethylene terephthalate (PET), polycarbonate (PC), poly(methyl methacrylate) (PMMA), polyethylene naphthalate (PEN), polyethersulfone (PES), cyclic olefin copolymer (COC), polydimethylsiloxane (PDMS), and polyurethane acrylate (PUA).

The rotary bodies may each include two display regions colored with different colors and having different electrical charge properties.

The two display regions of each rotary body may include a first display region colored white and a second display region colored black.

The two display regions of each rotary body may include a first display region colored white or black and a second display region colored red, green or blue.

The rotary bodies may include a spherical, oval or cylindrical shape.

According to another aspect of the present invention, there is provided a method of manufacturing an electronic paper display device, the method including: forming a partition wall structure having a plurality of partition walls and a plurality of cell spaces defined by the plurality of partition walls; disposing rotary bodies having optical and electrical anisotropy within the respective cell spaces; forming an elastomer matrix to cover the cell spaces and the rotary bodies; separating the partition wall and the elastomer matrix from each other to thereby obtain the elastomer matrix having protrusions corresponding to the cell spaces and predetermined intervals corresponding to the partition walls and formed between the protrusions; and forming first and second electrodes on the elastomer matrix.

The partition wall structure may be formed by an imprinting process, a laser patterning process, a photolithography process or an etching process.

A height of each partition wall may be smaller than a diameter of each rotary body.

The partition wall may have a width within a range of 110 to 130 μm.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically illustrating an electronic paper display device according to an exemplary embodiment of the present invention;

FIG. 2 is a perspective view schematically illustrating a rotary body according to an exemplary embodiment of the present invention; and

FIGS. 3A through 3E are cross-sectional views illustrating the process flow to illustrate a method of manufacturing an electronic paper display device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity. The same or equivalent elements are referred to with the same reference numerals throughout the specification.

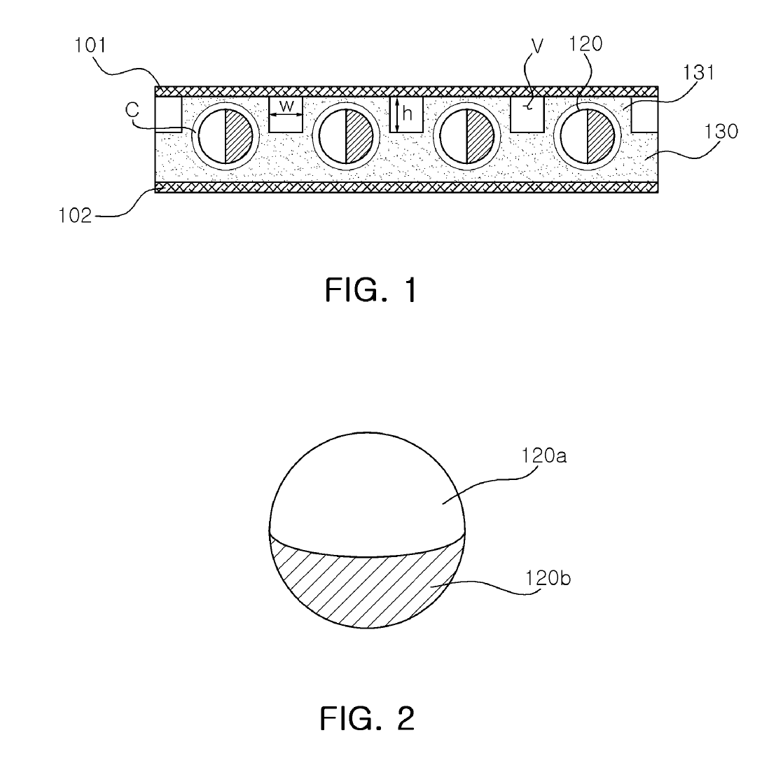

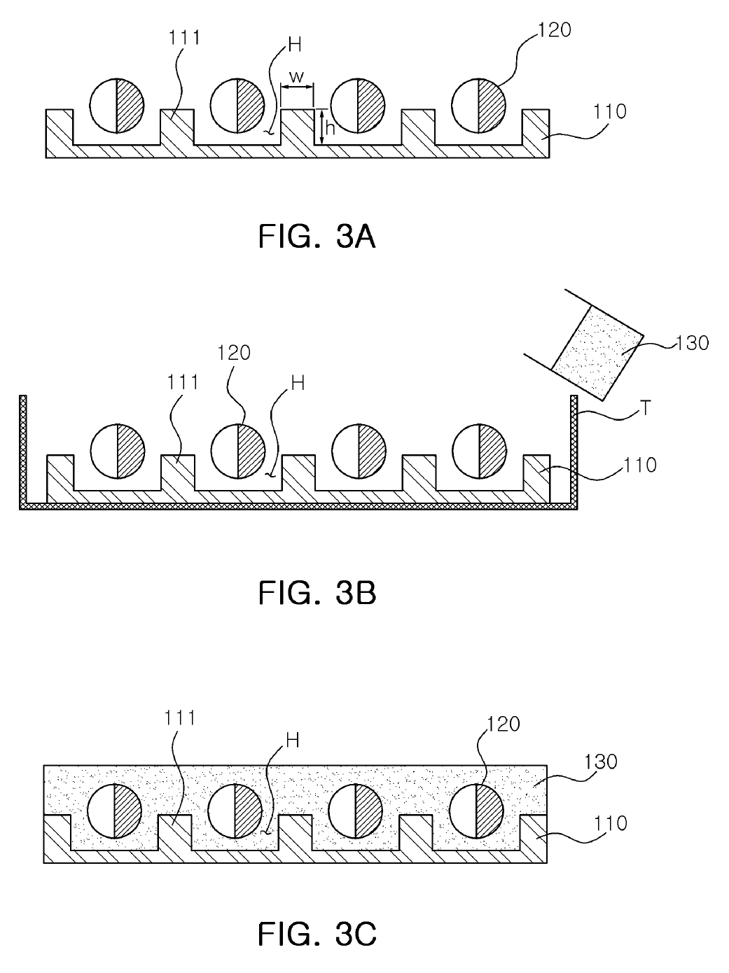

FIG. 1 is a schematic sectional view illustrating an electronic display device according to an exemplary embodiment of the invention. FIG. 2 is a perspective view enlarging a rotary body according to an exemplary embodiment of the invention.

Referring to FIG. 1, an electronic paper display device according to this embodiment includes first and second electrodes 101 and 102 facing each other, an elastomer matrix 130, and rotary bodies 120 interposed between the first and second electrodes 101 and 102.

The first and second electrodes 101 and 102 face each other. Voltage is applied to the rotary bodies 120 through the first and second electrodes 101 and 102. The electronic paper display device according to this embodiment may include a control unit (not shown) in order to control the magnitude and direction of voltage to be applied to the rotary bodies 120.

In this embodiment, the elastomer matrix 130 includes one or more protrusions 131. The protrusions 131 are formed at predetermined intervals V therebetween.

The rotary bodies 120 are disposed within the respective protrusions 131. One rotary body 120 may be disposed within one protrusion 131. However, the present invention is not limited thereto, and two or more rotary bodies 120 may be disposed within one protrusion 131.

While electronic paper is manufactured, the protrusions 131 facilitate the injection of a dielectric liquid around the rotary bodies 120, which will be described in detail below.

In this embodiment, the one or more protrusions 131, formed in the elastomer matrix 130, are arranged at the predetermined intervals V therebetween, thereby increasing the flexibility of electronic paper. That is, the above-described predetermined intervals V provide a space in which the elastomer matrix can be bent.

The protrusion 131 may have a height h smaller than a diameter of the rotary body 120 to be inserted therein. For example, the protrusion 131 may have the height h of 100 μm or less. A width W of the predetermined interval V is not particularly limited as long as it provides a space in which the elastomer matrix can be bent. The predetermined interval V may have the width W within the range of, for example, 110 to 130 μm.

The elastomer matrix 130 may be formed of a flexible resin, and may utilize, for example, polyethylene terephthalate (PET), polycarbonate (PC), poly(methyl methacrylate) (PMMA), polyethylene naphthalate (PEN), polyethersulfone (PES), cyclic olefin copolymer (COC), polydimethylsiloxane (PDMS), and polyurethane acrylate (PUA), and a mixture of thereof. The elastomer matrix 130 is not limited to the above described materials, however.

The elastomer matrix 130 may be formed of polydimethylsiloxane (PDMS) having high levels of viscosity so that the elastomer matrix 130, formed of polydimethylsiloxane (PDMS), can be easily bonded to or alienated from a different material.

The rotary bodies 120, individually disposed within the protrusions 131, have electrical and optical anisotropy. When receiving voltage, each of the rotary bodies 120, rotates such that the part of its body having an opposite polarity to the received electric charge faces the front. In such a manner, black and white are displayed.

Furthermore, the rotary bodies 120 may be disposed within a plurality of cavities C, each of which is filled with a dielectric liquid in order to facilitate the rotation of the rotary bodies 120.

FIG. 2 is a schematic perspective view enlarging one of the rotary bodies 120. Referring to FIG. 2, the rotary body 120 has two display regions 120a and 120b colored with different colors and having different electrical charge properties. The first display region 120a between the two display regions 120a and 120b may be colored white, while the second display region 120b may be colored black. While the first display region 120a is positively charged, the second display region 120b is negatively charged. When being applied with voltage, the rotary body 120 is rotated according to the magnitude and direction of the applied voltage, thereby displaying black or white depending on the colors of the two display regions.

A method known in the art may be used as the method of forming the first and second display regions 120a and 120b by electrically and optically treating the rotary body 120. For example, a method of putting a rotary body into a revolving disk provided with two coloring solutions and applying centrifugal force to the rotary body may be used.

The shape of each second rotary body 210 is not limited specifically. For example, the second rotary body 210 may have a spherical, oval or cylindrical shape. The diameter of the second rotary body 120 is not limited specifically, but may range from 50 μm to 120 μm, for example.

According to this exemplary embodiment, the two display regions are formed on the surface of the second rotary body 210. However, the number of display regions may be three or more as the need arises.

Further, the display regions may be colored with a variety of colors other than black or white.

For example, the first display region may be colored white or black, and the second display region 210b may be colored red, green or blue. Thus, each rotary body may display red, green or blue.

According to this embodiment, an electronic paper display device has a monolayer structure, in which rotary bodies are densely arranged with a small thickness. This improves a contrast ratio and reduces spacing between electrodes, thereby requiring relatively low driving voltage.

Furthermore, as described above, the one or more protrusions 131, formed in the elastomer matrix 130, are formed at the predetermined intervals V therebetween, and these predetermined intervals V provide a space in which the elastomer matrix can be bent, thereby increasing the flexibility of electronic paper.

Hereinafter, a method of manufacturing an electronic paper display device will be described.

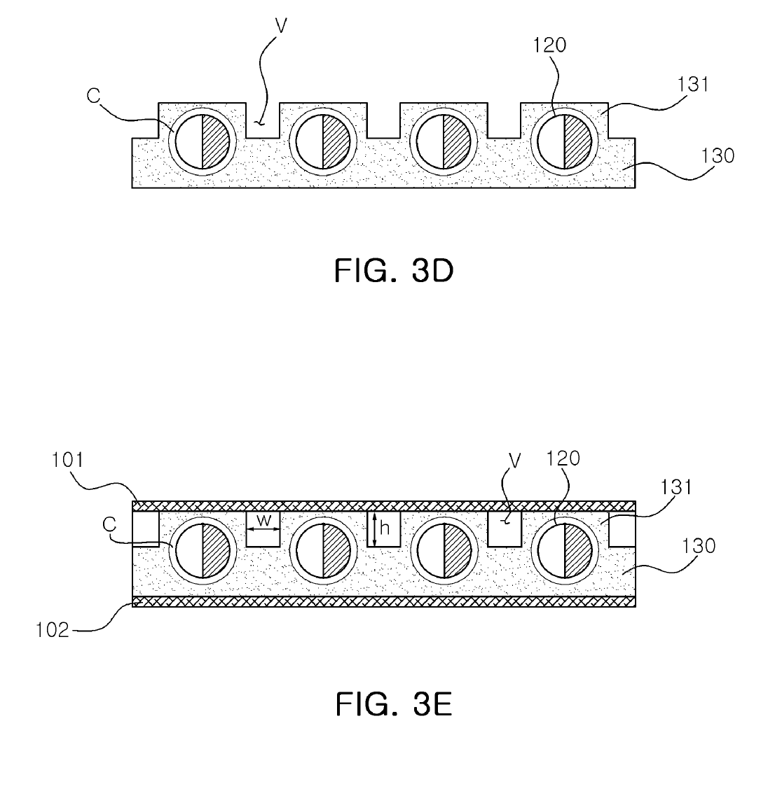

FIGS. 3A through 3E are cross-sectional views illustrating the process flow of a method of manufacturing an electronic paper display device according to an exemplary embodiment of the invention.

First, as shown in FIG. 3A, a partition wall structure 110 is formed. The partition wall structure 110 has partition walls 111 therein and a plurality of cell spaces H defined by the partition walls 111.

The partition wall structure 110 may be formed of a material having a high release property with respect to an elastomer matrix. The partition wall structure 110 may be formed of, for example, silicone, resin or the like, but is not limited thereto.

The partition wall structure may be formed to have a predetermined thickness by using silicone or resin. Then, partition walls may be formed by an imprinting process, a laser patterning process, a photolithography process or an etching process.

More specifically, after a resin layer having a predetermined thickness is formed, the resin layer is compressed by a stamp having raised and depressed patterns, so that partition walls and cell spaces corresponding to the raised and depressed patterns constitute a partition wall structure. Here, by controlling the raised and depressed patterns of the stamp, spacing between the partition walls and the shape and size of the cell spaces can be adjusted.

In this embodiment, a height h of the partition wall 111 may be smaller than a diameter of the rotary body 120. The height h of the partition wall 111 may be selected in a range that does not separate the rotary body 120, which will be disposed later, from the partition wall structure 110. For example, the partition wall may have the height h of 100 μm or less.

Furthermore, the partition wall may have a width W within a range of 110 to 130 μm.

Then, the rotary bodies 120 having electrical and optical anisotropy are disposed within the plurality of cell spaces H formed in the partition wall structure 110.

The rotary bodies 120 may be disposed in the cell spaces H by using a squeegee or the like. Specifically, a mask or a filter, exposing only the cell spaces H, is disposed on the substrate 110, and then the rotary bodies 120 may be injected into the cell spaces h by using a squeegee.

Then, as shown in FIGS. 3B and 3C, an elastomer matrix is formed to cover the cell spaces H of the partition wall structure 110 and the rotary bodies 120 disposed in the cell spaces.

More specifically, the partition wall structure 110 is disposed in a mold T that has a height greater than or equal to the partition walls 111 formed in the mold partition wall structure 110. Then, the elastomer matrix 130 is injected into the mold T. The elastomer matrix 130 is then cured at a predetermined temperature for a predetermined period of time. Subsequently, the mold T is removed. For example, when PDMS is used as an elastomer matrix, the curing process is completed after approximately 24 hours at room temperature, approximately 4 hours at a temperature of 70° C., approximately 1 hour at a temperature of 100° C., or approximately 15 minutes at a temperature of 150° C.

Then, as shown in FIG. 3D, once the elastomer matrix is cured, the partition wall structure 110 and the elastomer matrix 130 are separated from each other. The separated elastomer matrix 130 has the protrusions 131 corresponding to the cell spaces H of the partition wall structure 111. That is, the elastomer matrix 130, injected into the cell spaces H of the partition wall structure 111, forms the protrusions 131, and the rotary bodies 120 are disposed within the respective protrusions 131.

Furthermore, the elastomer matrix 130 has predetermined intervals V corresponding to the respective partition walls 111 of the partition wall structure 110, while the elastomer matrix is not injected between the predetermined intervals V. The height h and the width W of the predetermined interval V correspond to the height and width of the partition wall 111 formed in the partition wall structure 110.

Then, the elastomer matrix 130 is dipped into a dielectric liquid, and an ultrasonic process is carried out, thereby forming cavities C. When the elastomer matrix 130 is dipped into the dielectric liquid, the dielectric liquid permeates around the rotary bodies 120 and surrounds the rotary bodies 120 to thereby form the cavities C.

Here, since the rotary bodies 120 are disposed within the protrusions 131, a contact area between the dielectric liquid and the rotary bodies 120 is large. Therefore, an area into which the dielectric liquid can be injected is large to thereby facilitate the formation of the cavities C.

Then, as shown in FIG. 3E, the first electrode 101 and the second electrode 102 are formed in the elastomer matrix 130. More specifically, while the first electrode 101 is formed to cover the protrusions 131 and the predetermined interval V of the elastomer matrix, the second electrode 120 is formed at a position so as to face the first electrode 110.

The first and second electrodes may be formed of indium tin oxide (ITO) or the like.

As set forth above, according to exemplary embodiments of the invention, the electronic paper display device has a monolayer structure, in which rotary bodies are densely arranged within an elastomer matrix having a small thickness. Therefore, a contrast ratio is improved, and spacing between electrodes can be reduced to thereby require relatively low driving voltage.

Furthermore, one or more protrusions provided in an elastomer matrix are spaced apart at predetermined intervals therebetween, and these predetermined intervals provide a space in which the elastomer matrix can be bent, thereby increasing the flexibility of the electronic paper.

While the present invention has been shown and described in connection with the exemplary embodiments, it will be apparent to those skilled in the art that modifications and variations can be made without departing from the spirit and scope of the invention as defined by the appended claims.

What is claimed is:

1. An electronic paper display device comprising:
first and second electrodes facing each other;
an elastomer matrix provided between the first and second electrodes and having one or more protrusions spaced apart at predetermined intervals therebetween; and
one or more rotary bodies having optical and electrical anisotropy and being disposed within each of the protrusions.

2. The electronic paper display device of claim 1, wherein a height of each protrusion is smaller than a diameter of each rotary body.

3. The electronic paper display device of claim 1, wherein the predetermined interval has a width within a range of 110 to 130 μm.

4. The electronic paper display device of claim 1, wherein the elastomer matrix is at least one selected from the group consisting of polyethylene terephthalate (PET), polycarbonate (PC), poly(methyl methacrylate) (PMMA), polyethylene naphthalate (PEN), polyethersulfone (PES), cyclic olefin copolymer (COC), polydimethylsiloxane (PDMS), and polyurethane acrylate (PUA).

5. The electronic paper display device of claim 1, wherein the rotary bodies each comprise two display regions colored with different colors and having different electrical charge properties.

6. The electronic paper display device of claim 5, wherein the two display regions of each rotary body comprise a first display region colored white and a second display region colored black.

7. The electronic paper display device of claim 5, wherein the two display regions of each rotary body comprise a first display region colored white or black and a second display region colored red, green or blue.

8. The electronic paper display device of claim 1, wherein the rotary bodies comprise a spherical, oval or cylindrical shape.

9. A method of manufacturing an electronic paper display device, the method comprising:
forming a partition wall structure having a plurality of partition walls and a plurality of cell spaces defined by the plurality of partition walls;
disposing rotary bodies having optical and electrical anisotropy within the respective cell spaces;
forming an elastomer matrix to cover the cell spaces and the rotary bodies;
separating the partition wall and the elastomer matrix from each other to thereby obtain the elastomer matrix having protrusions corresponding to the cell spaces and predetermined intervals corresponding to the partition walls and formed between the protrusions; and
forming first and second electrodes on the elastomer matrix.

10. The method of claim 9, wherein the partition wall structure is formed by an imprinting process, a laser patterning process, a photolithography process or an etching process.

11. The method of claim 9, wherein a height of each partition wall is smaller than a diameter of each rotary body.

12. The method of claim 9, wherein the partition wall has a width within a range of 110 to 130 μm.
